(19) United States
(12) Patent Application Publication
(10) Pub. No.: US 2015/0323374 A1
(43) Pub. Date: Nov. 12, 2015

(54) ULTRASONIC FLOW METER AND ULTRASOUND ABSORBING BODY FAULT EVALUATING METHOD

(71) Applicant: Azbil Corporation, Tokyo (JP)

(72) Inventors: Koji MURAKI, Tokyo (JP); Tomohito HAYASHI, Tokyo (JP)

(73) Assignee: AZBIL CORPORATION, Tokyo (JP)

(21) Appl. No.: 14/705,137

(22) Filed: May 6, 2015

(30) Foreign Application Priority Data
May 7, 2014 (JP) 2014-096342

(51) Int. Cl. G01F 25/00; G01F 1/66

(52) U.S. Cl. CPC G01F 25/0053; G01F 1/662

(57) ABSTRACT

An ultrasonic flow meter includes: a first ultrasound transceiving portion provided on an outer periphery of an upstream side of piping; a second ultrasound transceiving portion provided on an outer periphery of a downstream side of the piping; a flow rate calculating portion that calculates a flow rate of a fluid based on time until a reception, by the second ultrasound transceiving portion, of an ultrasound transmitted by the first ultrasound transceiving portion and time until a reception, by the first ultrasound transceiving portion, of an ultrasound transmitted by the second ultrasound transceiving portion; an ultrasound absorbing body provided on an outer periphery of the piping; a piping-propagated wave identifying portion; an attenuation status value calculating portion; and a fault evaluating portion that evaluates that a fault has occurred in the ultrasound absorbing body.

### CROSS REFERENCE TO RELATED APPLICATION

This application claims priority under 35 U.S.C. §119 to Japanese Patent Application No. 2014-096342, filed on May 7, 2014, the entire content of which being hereby incorporated herein by reference.

### FIELD OF TECHNOLOGY

The present invention relates to an ultrasonic flow meter and ultrasound absorbing body fault evaluating method.

### BACKGROUND

Conventionally ultrasonic flow meters for measuring flow rates of various types of fluids have been proposed and reduced to practice. For example, at present a clamp-on ultrasonic flow meter is proposed wherein a bottom face portion of a wedge member that includes an oscillator is connected to the outer wall of piping through an acoustic coupling member. See, for example, Japanese Unexamined Patent Application Publication No. 2013-181812 (“the JP '812”). The clamp-on ultrasonic flow meter set forth in the JP '812 enables diagnostics of faults with the acoustic coupling member through comparing the sum of the frequency spectra of a specific diagnostic wave form to a prescribed threshold value.

However, in recent years there have been proposals for ultrasonic flow meters wherein one pair (or multiple pairs) of ultrasonic transceivers is disposed on outer walls of piping through which a fluid flows, with ultrasonic oscillators in angled wedges, to measure the respective propagation times when ultrasound is caused to pass through the fluid in the direction of flow and in the direction opposite of the flow, to calculate the flow rate of the fluid based on the difference in these propagation times.

In ultrasonic flow meters of the type that use the “differential propagation time method,” it is necessary to provide a damping member (an ultrasound absorbing material) on the outer periphery of the piping in order to suppress the signal that propagates through the piping (that part of the ultrasound that is produced by the ultrasonic oscillator that is reflected by the pipe wall of the piping to propagate through the piping). If the damping member breaks down or detaches, then it becomes impossible to measure the flow, and because often flow meters are installed in locations for which work is difficult, such as in high places, it is necessary to detect faults with the damping members early. However, at this point there are no proposals for methods for detecting effectively faults with damping members.

The present invention is created in contemplation of this situation, and an aspect thereof is to enable easy detection of faults with ultrasound absorbing materials for controlling signals that propagates through the piping in an ultrasonic flow meter that uses the differential propagation time method.

### SUMMARY

An ultrasonic flow meter according to present invention includes: a first ultrasound transceiving portion that carries out transmission and reception of ultrasound, provided on the outer periphery of an upstream side of piping wherein a fluid is flowing; a second ultrasound transceiving portion that carries out transmission and reception of ultrasound, provided on an outer periphery of a downstream side of the piping; a flow rate calculating portion that calculates a flow rate of the fluid based on the time until the reception, by the second ultrasound transceiving portion, of the ultrasound transmitted by the first ultrasound transceiving portion and the time until the reception, by the first ultrasound transceiving portion, of the ultrasound transmitted by the second ultrasound transceiving portion; and an ultrasound absorbing body that absorbs a piping-propagated wave of the ultrasound, provided on an outer periphery of the piping. The ultrasonic flow meter further includes: a piping-propagated wave identifying portion that identifies the piping-propagated wave; an attenuation status value calculating portion that acquires a value representing the state of attenuation of the piping-propagated wave identified by the piping-propagated wave identifying portion; and a fault evaluating portion that evaluates that a fault has occurred in the ultrasound absorbing body when a difference or ratio between the value representing the state of attenuation of the piping-propagated wave in a standard state and the value acquired by the attenuation status value acquiring portion exceeds a prescribed threshold value.

A method for detecting a fault in an ultrasound absorbing body according to the present invention uses an ultrasonic flow meter that includes: a first ultrasound transceiving portion that carries out transmission and reception of ultrasound, provided on the outer periphery of an upstream side of piping wherein a fluid is flowing; a second ultrasound transceiving portion that carries out transmission and reception of ultrasound, provided on an outer periphery of a downstream side of the piping; a flow rate calculating portion that calculates a flow rate of the fluid based on the time until the reception, by the second ultrasound transceiving portion, of the ultrasound transmitted by the first ultrasound transceiving portion and the time until the reception, by the first ultrasound transceiving portion, of the ultrasound transmitted by the second ultrasound transceiving portion; and an ultrasound absorbing body that absorbs a piping-propagated wave of the ultrasound, provided on an outer periphery of the piping. The method includes: a piping-propagated wave identifying step for identifying the piping-propagated wave; an attenuation status value calculating step for acquiring a value representing the state of attenuation of the piping-propagated wave identified in the piping-propagated wave identifying step; and a fault evaluating step for evaluating that a fault has occurred in the ultrasound absorbing body when a difference or ratio between the value representing the state of attenuation of the piping-propagated wave in a standard state and the value acquired in the attenuation status value acquiring step exceeds a prescribed threshold value.

The use of this structure and method makes it possible to evaluate that a fault has occurred in the ultrasound absorbing body by comparing a value that expresses the state of attenuation of the piping-propagated wave in a reference state and a value that expresses the state of attenuation of a specific piping-propagated wave, to identify a fault in the ultrasound absorbing body when the difference or ratio between the two exceeds a prescribed threshold value. That is, a fault (such as breakdown or separation) of the ultrasound absorbing body can be detected extremely easily by merely identifying a piping-propagated wave, acquiring a value that expresses the state of attenuation thereof, and comparing it to the value in a reference state. Consequently, it is possible to measure the timing over which the ultrasound absorbing body breaks down to thereby discern the appropriate replacement schedule, and possible to discover defects in installing during the initial installation. Note that the root mean square (RMS) for the piping-propagated wave, the difference between the maximum value and the minimum value of the piping-propagated wave, an integrated value for the piping-propagated wave, a SN ratio for the piping-propagated wave, or the like, can be used for the value for expressing the state of attenuation of the piping-propagated wave.

A piping-propagated wave identifying portion for identifying a piping-propagated wave based on an ultrasonic wave form that includes a wave that is a mixture of a fluid-propagated wave and a piping-propagated wave may be used in the ultrasonic flow meter according to the present invention.

The use of this structure makes it possible to identify a piping-propagated wave based on an ultrasonic wave form that includes a wave that is a mixture of a fluid-propagated wave and a piping-propagated wave. For example, when the ultrasonic waveform is displayed with time on the horizontal axis and voltage on the vertical axis, two straight lines are drawn from the maximum peak of the ultrasonic waveform to the minimum peaks on the left and right, where the intersections of these two straight lines with the horizontal axis can be used as the starting time and the ending time of the mixed wave, where the waveform that exists prior to a prescribed time after the time of the start of the mixed wave (or the waveform that exists up until a prescribed time after the end of the mixed waveform) can be identified as the piping-propagated wave.

The present invention enables the easy detection of a fault with an ultrasound absorbing member that is used in suppressing piping-propagated waves in an ultrasonic flow meter that uses the differential propagation time method.

### BRIEF DESCRIPTIONS OF THE DRAWINGS

FIG. 1 is a structural diagram illustrating schematically a structure for an ultrasonic flow meter according to an example according to the present invention.

FIG. 2 is an enlarged cross-sectional diagram for explaining the structure of a first ultrasound transceiving portion of the ultrasonic flow meter illustrated in FIG. 1.

FIG. 3 is an explanatory diagram for explaining a method for calculating the flow rate of gas that flows within the piping, using the ultrasonic flow meter illustrated in FIG. 1.

FIG. 4 is an explanatory diagram for explaining the state of reception, by a second ultrasound transceiving portion, of ultrasound that is transmitted from the first ultrasound transceiving portion of the ultrasonic flow meter illustrated in FIG. 1.

FIG. 5 is a block diagram for explaining the functional structure of a calculating/controlling portion of a main unit portion of an ultrasonic flow meter illustrated in FIG. 1.

FIG. 6 is a graph of for explaining a method for identifying a piping-propagated wave.

FIG. 7 is a graph illustrating the result of tests for setting a standard value used in evaluating faults with an ultrasound absorbing body.

FIG. 8 is a flowchart for explaining a method for evaluating faults with an ultrasound absorbing body according to an example according to the present invention.

### DETAILED DESCRIPTION

Examples of the present invention will be explained in detail below while referencing the drawings. In the descriptions of the drawings below, identical or similar parts are expressed by identical or similar codes. Note that the drawings do not express the actual dimensions, and specific dimensions, and the like, should be determined in light of the explanations below. Furthermore, even within these drawings there may, of course, be portions having differing dimensional relationships and proportions. Moreover, in the explanations below the top of the figure shall be defined as “up,” the bottom of the figure shall be defined as “down,” the left side of the figure shall be defined as “left,” and the right side of the figure shall be defined as “right.”

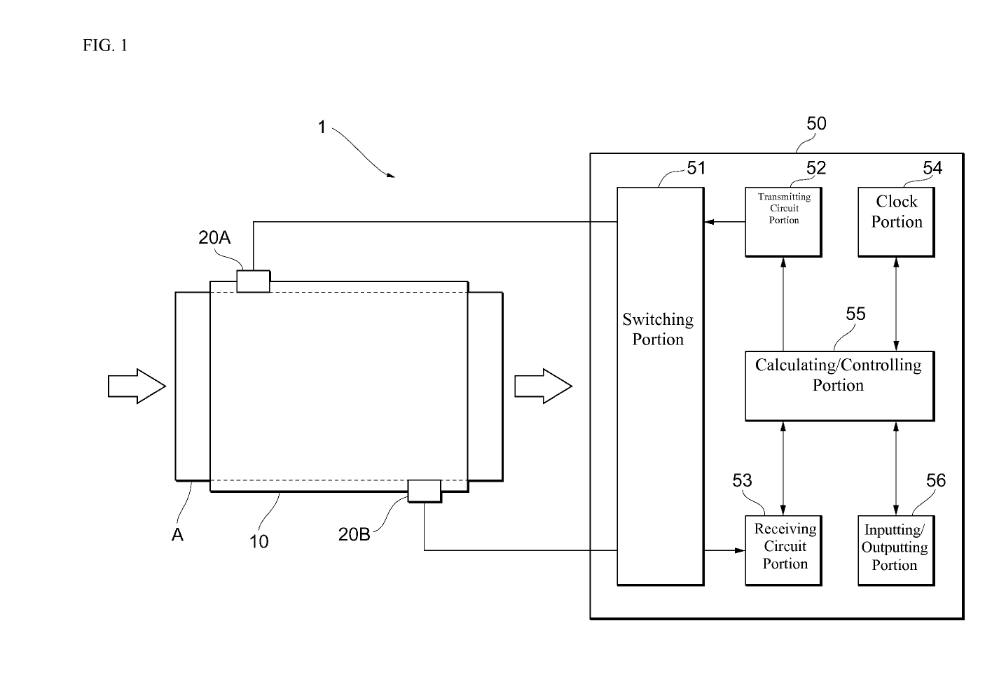

The structure of an ultrasonic flow meter 1 according to an example according to the present invention will be explained first using FIG. 1 through FIG. 7. The ultrasonic flow meter 1 according to the present example, as illustrated in FIG. 1, is for measuring the flow rate of air (a gas) that flows within a pipe A. The gas, which is that which is subject to measurement by the ultrasonic flow meter 1, flows in the direction indicated by the white arrow in FIG. 1 (the left-to-right direction in FIG. 1). The ultrasonic flow meter 1 is provided with a first ultrasound transceiving portion 20A, a second ultrasound transceiving portion 20B, a main unit portion 50, and an ultrasound absorbing body 10.

The first ultrasound transceiving portion 20A and the second ultrasound transceiving portion 20B are each provided on the outer periphery of the pipe A. In the example illustrated in FIG. 1, the first ultrasound transceiving portion 20A is disposed on the upstream side on the pipe A and the second ultrasound transceiving portion 20B is disposed on the downstream side on the pipe A. The first ultrasound transceiving portion 20A and the second ultrasound transceiving portion 20B each carry out transmission and reception of ultrasound, to transmit ultrasound to each other and receive ultrasound from each other. That is, the ultrasound that is transmitted from the first ultrasound transceiving portion 20A is received by the second ultrasound transceiving portion 20B, and the ultrasound transmitted by the second ultrasound transceiving portion 20B is received by the first ultrasound transceiving portion 20A.

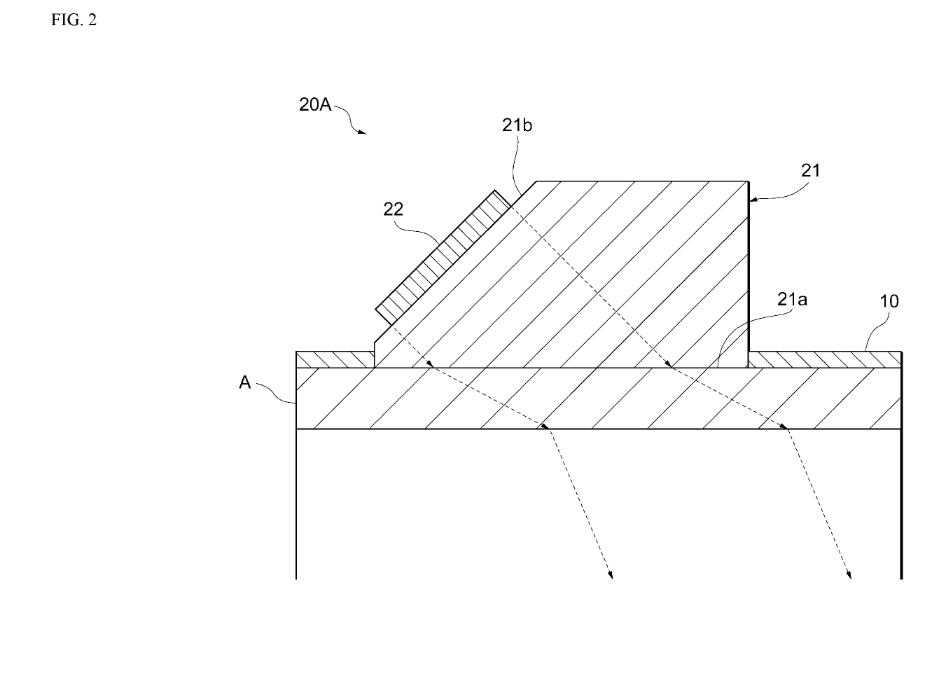

The first ultrasound transceiving portion 20A, as illustrated in FIG. 2, is provided with a wedge 21 and a piezoelectric element 22.

The wedge 21 is for injecting ultrasound at a prescribed acute angle into the pipe A, and is a member that is made out of resin or metal. In the wedge 21, the bottom face 21a is positioned so as to contact an outer peripheral surface of the pipe A. Moreover, in the wedge 21 an angled face 21b is formed having a prescribed angle relative to the bottom face 21a. The piezoelectric element 22 is provided in this angled face 21b. While an example where in the bottom face 21a is in contact with an outer peripheral surface of the pipe A is illustrated in the present example, there is no limitation thereto. A contacting medium (a couplant) may be interposed between the bottom face 21a and the outer peripheral surface of the pipe A.

The piezoelectric element 22 both transmits ultrasound and also receives ultrasound. The piezoelectric element 22 is connected electrically by lead lines (not shown). When an electric signal of a prescribed frequency is applied through the lead lines, the piezoelectric element 22 vibrates at the prescribed frequency to emit ultrasound. Ultrasound is transmitted thereby. As illustrated by the dotted arrow in FIG. 2, the ultrasound that is transmitted by the piezoelectric element 22 propagates through the wedge 21 at the angle of the angled face 21b. The ultrasound that passes through the wedge 21 is diffracted at the interface between the wedge 21 and the outer wall of the pipe A, to change the angle of incidence, and is also refracted at the interface between the inner wall of the pipe A and the gas that flows within the pipe A, changing the angle of incidence again, and propagates through the gas. The refraction at the interface follows Snell's law, where the angle of the angled face 21b is set in advance based on the speed of the ultrasound when propagating through the pipe A and the speed of the ultrasound when propagating through the gas, to enable the ultrasound to be incident into the gas at a desired angle of incidence, to propagate therein.

On the other hand, when the ultrasound reaches the piezoelectric element 22, the piezoelectric element 22 vibrates at the frequency of the ultrasound to produce an electric signal. The ultrasound is received in this way. The electric signal produced by the piezoelectric element 22 passes through the lead lines to be detected by the main unit portion 50, described below.

Note that the second ultrasound transceiving portion 20B is provided with a structure that is similar to that of the first ultrasound transceiving portion 20A.

That is, the second ultrasound transceiving portion 20B is also provided with a wedge 21 and a piezoelectric element 22. Because of this, the detailed explanation of the second ultrasound transceiving portion 20B is omitted, based on the explanation of the first ultrasound transceiving portion 20A, set forth above.

At the main unit portion 50, illustrated in FIG. 1, is for measuring the flow rate of the gas based on the time of propagation of the ultrasound through the gas that flows within the pipe A. The main unit portion 50 is provided with a switching portion 51, a transmitting circuit portion 52, a receiving circuit portion 53, a clock portion 54, a calculating/controlling portion 55, and an inputting/outputting portion 56.

The switching portion 51 is for switching between transmitting and receiving the ultrasound. The switching portion 51 is connected to the first ultrasound transceiving portion 20A and the second ultrasound transceiving portion 20B. The switching portion 51 may be structured including, for example, a switching switch. The switching portion 51 switches the switching switch based on a control signal inputted from the calculating/controlling portion 55, to connect either the first ultrasound transceiving portion 20A or the second ultrasound transceiving portion 20B to the transmitting circuit portion 52, and to connect the other one, of the first ultrasound transceiving portion 20A and the second ultrasound transceiving portion 20B, to the receiving circuit portion 53. This makes it possible to transmit ultrasound from either the first ultrasound transceiving portion 20A for the second ultrasound transceiving portion 20B, and to receive ultrasound through the other one of the first ultrasound transceiving portion 20A and the second ultrasound transceiving portion 20B.

The transmitting circuit portion 52 is for causing the first ultrasound transceiving portion 20A and the second ultrasound transceiving portion 20B to transmit ultrasound. The transmitting circuit portion 52 may be structured through, for example, an oscillating circuit for generating a square wave of a prescribed frequency, and a driving circuit for driving the first ultrasound transceiving portion 20A and the second ultrasound transceiving portion 20B. The transmitting circuit portion 52 outputs, to the piezoelectric element 22 of either the first ultrasound transceiving portion 20A more the second ultrasound transceiving portion 20B, a driving signal that is a square wave that the driving circuit generates through the oscillating circuit, based on a control signal that is inputted from the calculating/controlling portion 55. As a result, the piezoelectric element 22 of either the first ultrasound transceiving portion 20A or the second ultrasound transceiving portion 20B is driven so that the piezoelectric element 22 transmits ultrasound.

The receiving circuit portion 53 is for detecting the ultrasound that is received by the first ultrasound transceiving portion 20A and the second ultrasound transceiving portion 20B. The receiving circuit portion 53 can, for example, be structured including an amplifying circuit for amplifying the signal with a prescribed gain, and a filter circuit for reading out an electric signal of a prescribed frequency. The receiving circuit portion 53, based on a control signal that is inputted from the calculating/controlling portion 55, amplifies and filters the electric signal outputted from the piezoelectric element 22 of either the first ultrasound transceiving portion 20A or the second ultrasound transceiving portion 20B, to convert into a received signal. The received signal that has been converted is outputted by the receiving circuit portion 53 to the calculating/controlling portion 55.

The clock portion 54 is for measuring time over a prescribed interval. The clock portion 54 may be structured from, for example, an oscillating circuit, or the like. Note that the oscillating circuit may be shared with that of the transmitting circuit portion 52. The clock portion 54 counts the number of reference waves of the oscillating circuit to measure time based on a start signal and a stop signal inputted from the calculating/controlling portion 55. The clock portion 54 outputs, to the calculating/controlling portion 55, the measured time.

The calculating/controlling portion 55 is that which performs calculations through calculating the flow rate of the gas that flows within the pipe A. The calculating/controlling portion 55 may be structured from, for example, a CPU, memory such as a ROM or a RAM, an input/output interface, and the like. Moreover, the calculating/controlling portion 55 controls the various portions of the main unit portion 50 such as the switching portion 51, the transmitting circuit portion 52, the receiving circuit portion 53, the clock portion 54, and the Inputting/outputting portion 56. Note that the method with which the calculating/controlling portion 55 calculates the flow rate of the gas will be described below.

The inputting/outputting portion 56 is for inputting information from the user and for outputting information to the user. The inputting/outputting portion 56 may be structured through, for example, inputting means such as operating buttons and outputting means such as a display. Various types of information, such as settings, are inputted into the calculating/controlling portion 55 through the inputting/outputting portion 56 through the operator operating the operating buttons, and the like. Moreover, the inputting/outputting portion 56 outputs information, such as the calculated airflow rate, gas speed, flow over a prescribed interval, and the like, through the calculating/controlling portion 55 displaying on the display.

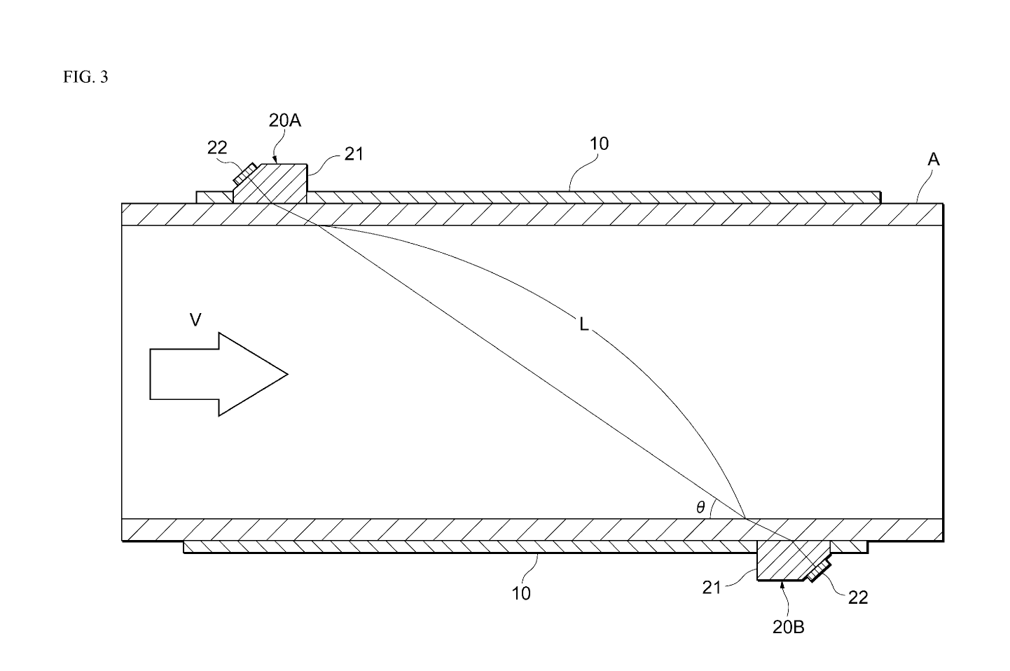

Here the method for calculating the flow rate of the gas that flows within the pipe A will be explained using FIG. 3. As illustrated in FIG. 3, the speed of the gas that flows in a prescribed direction within the pipe A (the direction from the left to the right in FIG. 3) (where the speed is defined as the “flow speed,” below) is defined V (m/s), and the speed with which the ultrasound propagates within the gas (hereinafter defined as the “speed of sound”) is defined as C (m/s), with the propagation path length of the ultrasound that propagates through the gas defined as L (meters), and the angle formed by the axis of the pipe A and the ultrasound propagation path is defined as θ. Here the propagation time T₁2 for the ultrasound to propagate through the gas within the pipe A when the first ultrasound transceiving portion 20A, which is disposed on the upstream side of the pipe A (the side on the left in FIG. 3) transmits ultrasound and the second ultrasound transceiving portion 20B, which is disposed on the downstream side of the pipe A (the side on the right in FIG. 3) receives the ultrasound, is expressed by Equation (1), below:

T₁₂=L/(C+V cos θ) (1)

On the other hand, the propagation time T₂₁ for the ultrasound to propagate through the gas within the pipe A when the second ultrasound transceiving portion 20B, which is disposed on the downstream side of the pipe A transmits ultrasound and the first ultrasound transceiving portion 20A, which is disposed on the uptream side of the pipe A receives the ultrasound, is expressed by Equation (2), below:

T₂₁=L/(C−V cos θ) (2)

From Equation (1) and Equation (2), the flow speed V of the gas is expressed through Equation (3), below:

V=(L/2 cos θ)·{(1/T₁2)−(1/T₂₁)} (3)

In Equation (3) the propagation path length L and angle θ are known values prior to measuring the flow rate, so the flow speed V can be calculated from Equation (3) through measuring the propagation time T₁2 and the propagation time T₂1.

Additionally, the flow rate Q (m³/s) of the gas that flows within the pipe A is expressed through the following Equation (4) using the flow speed V (m/s), a complement coefficient K, and the cross-sectional area S (m²) of the pipe A:

Q=KVS (4)

Consequently, the calculating/controlling portion 55 stores the propagation path length L, the angle θ, the complement coefficient K, and the cross-sectional area S of the pipe A in advance in memory, or the like. Given this, the calculating/controlling portion 55, by measuring the propagation time T₁2 and the propagation time T₂1, using the clock portion 54, is able to calculate the flow rate Q of the gas that flows within the pipe A using Equation (3) and Equation (4) based on the reception signal is inputted from the receiving circuit portion 53. That is, the calculating/controlling portion 55 functions as the flow rate calculating portion in the present invention.

In the form of calculation in the present example, it is illustrated that the flow rate of the gas is calculated using an inverted propagation time difference method using FIG. 3 and Equations (1) through (4); however, there is no limitation thereto. The calculating/controlling portion 55 may calculate the flow rate through another method instead, such as, for example, the well-known differential propagation time method.

Note that in FIG. 1 an example is illustrated wherein the first ultrasound transceiving portion 20A is disposed on the upstream side of the pipe A and the second ultrasound transceiving portion 20B is disposed on the downstream side of the pipe A, in FIG. 1, so as to cause the first ultrasound transceiving portion 20A and the second ultrasound transceiving portion 20B to mutually face each other, there is no limitation thereto. The first ultrasound transceiving portion 20A and the second ultrasound transceiving portion 20B need only be disposed on the outer peripheries of the upstream side and downstream side of the pipe A.

Moreover, while in the form of calculation in the present example, it is shown that the ultrasound that is transmitted from the first ultrasound transceiving portion 20A and the second ultrasound transceiving portion 20B passes through the gas within the pipe A and is received directly by the other one of the first ultrasound transceiving portion 20A and the second ultrasound transceiving portion 20B, there is no limitation thereto. The ultrasound that propagates through the gas within the pipe A may be reflected by an inner wall of the pipe A. Consequently, the other one of the first ultrasound transceiving portion 20A and the second ultrasound transceiving portion 20B may instead receive the ultrasound that has been reflected 2n times (where n is a positive even number) by the inner walls of the pipe A.

Typically, “ultrasound” refers to sound waves in a frequency band of above 20 kHz. As a result, the ultrasound emitted from the first ultrasound transceiving portion 20A and from the second ultrasound transceiving portion 20B is ultrasound in a frequency band of above 20 kHz. Preferably, the ultrasound that is emitted by the first ultrasound transceiving portion 20A and the second ultrasound transceiving portion 20B is ultrasound in a frequency band that is above 100 kHz and below 2.0 MHz. More preferably, the ultrasound that is emitted by the first ultrasound transceiving portion 20A and the second ultrasound transceiving portion 20B is ultrasound in a frequency band that is above 0.5 MHz and below 1.0 MHz. Note that in any case, the ultrasound that is emitted from the ultrasound transceiving portion 20A and the ultrasound that is emitted from the ultrasound transceiving portion 20B may be of identical frequencies or may be of different frequencies.

The ultrasound absorbing body 10 illustrated in FIG. 1 is provided on an outer peripheral surface of the pipe A. Specifically, the ultrasound absorbing body 10 is disposed so as to cover a region of the outer peripheral surface of the pipe A between the first ultrasound transceiving portion 20A and the second ultrasound transceiving portion 20B, and secured in intimate contact with the outer peripheral surface of the pipe A. In the ultrasound absorbing body 10, parts for locating the first ultrasound transceiving portion 20A and the second ultrasound transceiving portion 20B are cut out in frame shapes in portions of the ultrasound absorbing body 10, so that the first ultrasound transceiving portion 20A and the second ultrasound transceiving portion 20B will make direct contact with the outer peripheral face of the pipe A.

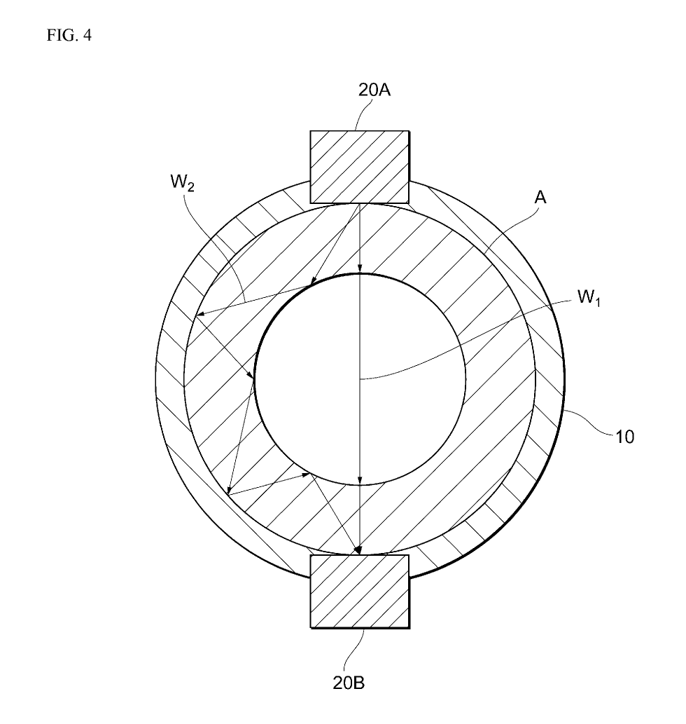

FIG. 4 is an cross-sectional diagram for explaining the state of reception, by a second ultrasound transceiving portion 20B, of ultrasound that is transmitted from the first ultrasound transceiving portion 20A. As illustrated in FIG. 4, for example, the ultrasound that is transmitted from the first ultrasound transceiving portion 20A is divided into the gas-propagated wave W₁ that passes through the pipe A to propagate within the gas within the pipe A, and the piping-propagated wave W₂ that is reflected by the pipe wall of the pipe A to propagate within the pipe A. The gas-propagated wave W₁ passes again through the pipe A to arrive at the second ultrasound transceiving portion 20B. On the other hand, the piping-propagated wave W₂ also arrives at the second ultrasound transceiving portion 20B while reflecting multiple times from the inner wall and the outer wall of the pipe A. While diagrams and explanations of details thereof are omitted, the ultrasound that is transmitted from the second ultrasound transceiving portion 20B is also divided into an gas-propagated wave W₁ and a piping-propagated wave W₂, in the same manner as the ultrasound that is transmitted by the first ultrasound transceiving portion 20A, where the gas-propagated wave W₁ passes through the pipe A to arrive at the first ultrasound transceiving portion 20A, and the piping-propagated wave W₂ can also arrive at the first ultrasound transceiving portion 20A while reflecting multiple times on the inner wall and the outer wall of the pipe A.

Typically whether the sound waves that propagate through one of the media are transmitted (pass-through) the interface with the other medium or are reflected thereby is determined by the difference in the acoustic impedances of the one medium and the other medium. That is, the smaller the difference in acoustic impedances, the greater the tendency for transmission of the sound waves that are propagating through one pipe that will be transmitted into the other medium, and the greater the difference in acoustic impedances, the greater the tendency for the sound waves that are propagating within the one pipe to be reflected at the interface with the other medium.

If the fluid that is flowing within the pipe A is, for example, a liquid, the difference between the acoustic impedance of the liquid and the acoustic impedance of the piping material, such as a metal such as stainless steel (SUS) or a polymer compound, such as a synthetic resin, will be relatively small, so that the proportion of the ultrasound that passes through the pipe A to propagate through the liquid that is flowing therein (the “transmissivity”) will be high, that is, the proportion that is reflected by the pipe walls of the pipe A (the “reflectivity”) will be low, and thus the energy (magnitude or strength) of the piping-propagated wave W₂ will be small. On the other hand, the acoustic impedance of gas is small when compared to the acoustic impedance of a liquid. because of this, when the fluid that flows within the pipe A is gas, the difference between the acoustic impedance of the gas and the acoustic impedance of the pipe A will be relatively large, and thus the proportion of the ultrasound that passes through the pipe A to propagate within the gas that flows there within (the transmissivity) will be low, that is, the proportion that is reflected by the pipe wall of the pipe A will be large, and the energy (the magnitude or strength) of the piping-propagated wave W₂ will be large.

Here, in an ultrasonic flow meter wherein the gas-propagated wave W₁ of the ultrasound is received, the propagation time is measured, and the flow rate is measured based on the propagation time, the gas-propagated wave W₁ is the signal (signal component) that is to be detected, where the piping-propagated wave W₂ is noise (English component) relative to the signal. As a noise component, the piping-propagated wave W₂ has a tendency to increase as the ultrasound absorbing body 10 breaks down or becomes detached. In order to detect quickly such a fault in the ultrasound absorbing body 10 (breakdown or detachment), the calculating/controlling portion 55 in the present example has a functional structure such as described below.

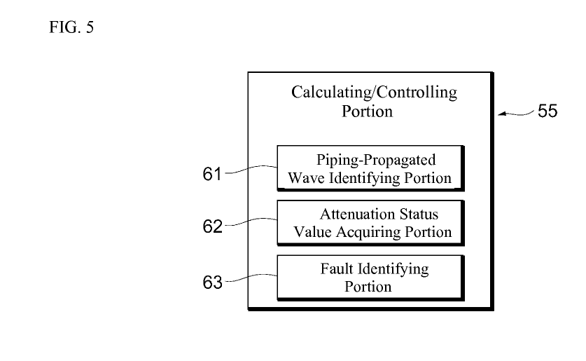

Specifically, the calculating/controlling portion 55, as illustrated in FIG. 5, has: a piping-propagated wave identifying portion 61 for identifying a piping-propagated wave W₂; an attenuation status value acquiring portion 62 for acquiring a value indicating the state of attenuation of the piping-propagated wave W₂ identified by the piping-propagated wave identifying portion 61; and a fault evaluating portion 63 for evaluating whether or not a fault has occurred in the ultrasound absorbing body 10 when a difference or ratio between a value that indicates the state of attenuation of the piping-propagated wave W₂ in a reference state and the value acquired by the attenuation status value acquiring portion 62 exceeds a prescribed threshold value.

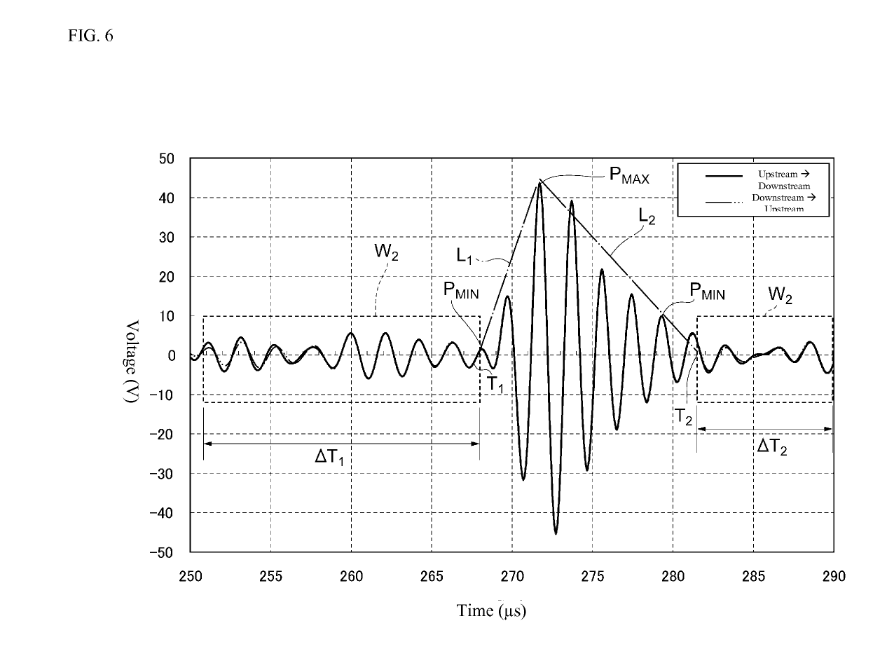

The piping-propagated wave identifying portion 61 in the present example identifies the piping-propagated wave W₂ based on the ultrasound waveform that includes the mixed wave (the gas-propagated wave W₁ and the piping-propagated wave W₂). Specifically, as illustrated in FIG. 6, when the ultrasound waveform is displayed, using time (μsec) on the horizontal axis and voltage (V) on the vertical axis, if two straight lines L₁ and L₂ are drawn from the maximum peak P_{MAX} of the ultrasound waveform to the minimum peaks P_{MIN} to the left and to the right, and the intersecting points T₁ and the T₂ between these two lines L₁ and L₂ and the horizontal axis are defined as the starting time and ending time for the respective mixed waves, then a waveform that exists prior to a prescribed time ΔT₁ after the mixed wave starting time T₁ and/or a waveform that exists after a prescribed time ΔT₂ after the mixed waveform ending time T₂ can be identified as a piping-propagated wave W₂. ΔT₂ may be a value that is different from ΔT₁.

Here the maximum P_{MAX} refers to the peak with the maximum value among the peaks in the ultrasound, as illustrated in FIG. 6. Moreover, the minimum peaks P_{MIN} on the left and the right refer to the peaks in the ultrasound waveform that are in the vicinity of the maximum P_{MAX} (for example, within two through four peaks) to the left (with which is temporally earlier) or the right (which is temporally later), that are the smallest. For example, as illustrated in FIG. 6, the smallest of the two peaks in the vicinity on the left-hand side of the maximum peak P_{MAX} can be defined as the left minimum P_{MIN}, and the peak that is the smallest of the four peaks that are in the vicinity of the right-hand side of the maximum peak P_{MAX} can be defined as the right minimum peak P_{MIN}. Note that while in the present example the peak having the maximum value in the positive direction is defined as P_{MAX}, the peak having the maximum value in the minimum direction may instead be defined as P_{MAX}.

Note that, as has already been discussed, there are two different ultrasounds, that which is transmitted by the first ultrasound transceiving portion 20A on the upstream side and received by the second ultrasound transceiving portion 20B on the downstream side (the “upstream-transmitted ultrasound”), and that which is transmitted by the second ultrasound transceiving portion 20B on the downstream side and received by the first ultrasound transceiving portion 20A on the upstream side (the “downstream-transmitted ultrasound”). The graph with the heavy line in FIG. 6 shows the waveform of the upstream-transmitted ultrasound, while the graph with the thin line in FIG. 6 shows the waveform of the downstream-transmitted ultrasound. A set of two-propagated waves (the upstream-transmitted piping-propagated wave and the downstream-transmitted piping-propagated wave) can be identified based on these two ultrasound waveforms.

The attenuation status value acquiring portion 62 acquires a value indicating the state of attenuation of the piping-propagated wave W₂ identified by the piping-propagated wave identifying portion 61. Here the value that indicates the state of attenuation of the piping-propagated wave W₂ may use a root mean square of the piping-propagated wave W₂, a difference between a maximum value and a minimum value for the piping-propagated wave W₂, an integrated value of the piping-propagated wave W₂, an SN ratio for the piping-propagated wave, or the like. For example, when the piping-propagated wave identifying portion 61 has identified the waveform that exists prior to a prescribed time ΔT₁ after the start of the mixed wave as being a piping-propagated wave W₂, the attenuation status value acquiring portion 62 may calculate the RMS of the piping-propagated wave W₂ at the prescribed time ΔT₁ as the value that indicates the state of attenuation, as illustrated in FIG. 6.

The fault evaluating portion 63 evaluates that a fault has occurred in the ultrasound absorbing body 10 if the difference between a value indicating the state of attenuation of the piping-propagated wave W₂ in a reference state (a standard value) and the value acquired by the attenuation status value acquiring portion 62 (a measured value) exceeds a prescribed threshold value. Here the “standard value” can use a default value acquired directly after installation of the ultrasound absorbing body 10 (a value indicating the state of attenuation of the piping-propagated wave W₂ when the ultrasound absorbing body 10 is in the normal state), may use a value acquired in advance experimentally, or the like.

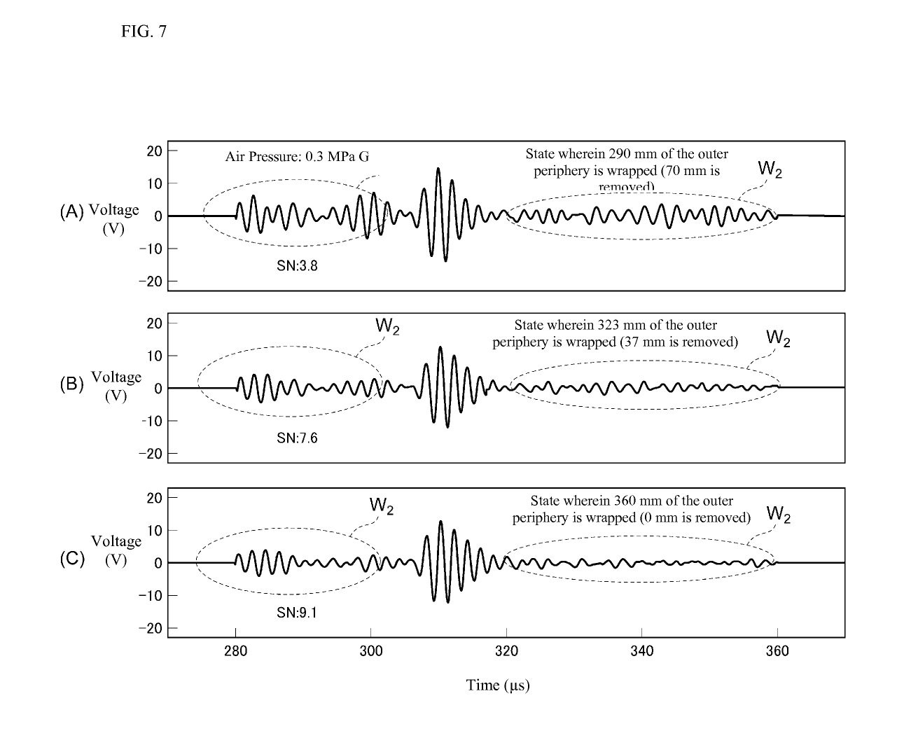

FIG. 7 is a graph illustrating experimental results for setting a “standard value” to be used by the fault evaluating portion 63, illustrating the ultrasound waveform when the pressure of the gas that is subject to measurement is set at 0.3 MPa. In FIG. 7, time (μsec) is indicated on the horizontal axis and voltage (V) is indicated on the vertical axis. FIG. 7 (A) is an ultrasound waveform when a 70 mm part of the outer periphery in an ultrasound absorbing body with a 360 mm outer periphery has become detached, at which time the piping-propagated wave W₂ that has been identified is the waveform in the part that is enclosed in the dotted line, and the SN ratio, which is the value indicating the state of attenuation, was 3.8. FIG. 7 (B) is an ultrasound waveform when a 37 mm part of the outer periphery in an ultrasound absorbing body with a 360 mm outer periphery has become detached, at which time the piping-propagated wave W₂ that has been identified is the waveform in the part that is enclosed in the dotted line, and the SN ratio, which is the value indicating the state of attenuation, was 7.6. FIG. 7 (C) is an ultrasound waveform when absolutely none the outer periphery in an ultrasound absorbing body with a 360 mm outer periphery has become detached, at which time the piping-propagated wave W₂ that has been identified is the waveform in the part that is enclosed in the dotted line, and the SN ratio, which is the value indicating the state of attenuation, was 9.1. From this experiment, the “standard value” was set to (SN ratio=) 9.1.

The threshold value used by the fault evaluating portion 63 can be set as appropriate depending on the type of value for indicating the state of attenuation of the piping-propagated wave W₂, the ultrasound waveform, or the like. For example, when the threshold value is set to 2.0, then the case in FIG. 7 (B) is a difference of 1.5 between the standard value (9.1) and the measured value (7.6), which is less than the threshold value, and thus the evaluation will be that there is no fault in the ultrasound absorbing body 10, where in the case in FIG. 7 (A), there is a difference of 5.3 between the standard value (9.1) and the measured value (2.8), which exceeds the aforementioned threshold, and thus the evaluation will be that the fault has occurred in the ultrasound absorbing body 10. On the other hand, if the threshold value is set to 1.0, then the difference between the standard value and the measured value in the case in FIG. 7 (B) will also exceed the threshold value, so the evaluation will be that a fault has occurred in the ultrasound absorbing body 10.

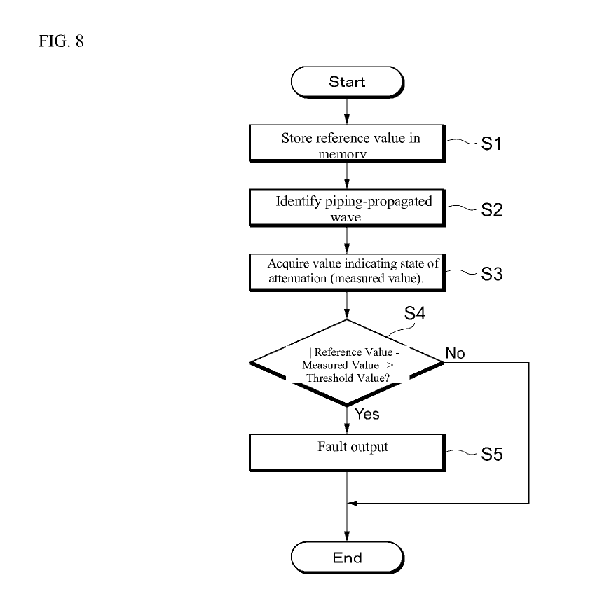

The flowchart in FIG. 8 will be used next to explain a method of evaluating a fault in the ultrasound absorbing body 10 of the ultrasonic flow meter 1 in the present example.

First the standard value (the value indicating the state of attenuation of the piping-propagated wave W₂ in the standard state), used in the evaluation of a fault with the ultrasound absorbing body 10, is stored in the memory of the calculating/controlling portion 55 of the ultrasonic flow meter 1 (Standard value storing step: S1). For the standard value, as described above, a default value, acquired immediately after installation of the ultrasound absorbing body 10, or a value acquired in advance experimentally, or the like, may be used.

Following this, the piping-propagated wave identifying portion 61 of the calculating/controlling portion 55 identifies the piping-propagated wave W₂ (Piping-propagated wave identifying step: S2). As described above, in the Piping-propagated wave identifying step S2, as illustrated in FIG. 6, the mixed wave beginning time T₁ is identified based on the waveform of the ultrasound, and the waveform that exists prior to a prescribed time ΔT₁ after the mixed wave start time T₁ is identified as the piping-propagated wave W₂.

Following this, the attenuation status acquiring portion 62 of the calculating/controlling portion 55 acquires a value (a measured value) indicating the state of attenuation of the piping-propagated wave W₂ (Attenuation status value acquiring step: S3). If, for example, as illustrated in FIG. 6, the waveform that exists at the prescribed time ΔT₁ is identified as a piping-propagated wave W₂ in the Piping-propagated wave identifying step S2, then the RMS of the piping-propagated wave W₂ at the prescribed time ΔT₁ can be calculated (acquired) as the value (measured value) representing the state of attenuation.

Following this, the fault evaluating portion 63 of the calculating/controlling portion 55 evaluates whether or not the difference between the standard value that was stored in the Standard value storing step S1 and the value acquired in the Attenuation status value acquiring step S3 (the measured value) is greater than a prescribed threshold value (Fault evaluating step: S4). Given this, if the difference between the standard value and the measured value is greater than the prescribed threshold value, then the fault evaluating portion 63 defines that a fault has occurred in the ultrasound absorbing body 10, and outputs prescribed warning information by displaying on the display of the inputting/outputting portion 56 (Fault outputting step: S5), after which control is terminated. On the other hand, if the difference between the standard value and the measured value is not greater than the prescribed threshold value, the fault evaluating portion 63 determines that no fault has occurred in the ultrasound absorbing body 10, and terminates control as-is.

In the ultrasonic flow meter 1 in the example explained above, an evaluation that a fault has occurred in the ultrasound absorbing body 10 is produced when, in a comparison of the value (the standard value) indicating the state of attenuation of the piping-propagated wave W₂ in the standard state and the value (the measured value) indicating the state of attenuation of the piping-propagated wave W₂ that has been identified are compared, and the difference between the two exceeds a prescribed threshold value. That is, by merely identifying the piping-propagated wave W₂, acquiring a value that indicates the state of attenuation (the measured value), and comparing to the value for the standard state (the standard value) it is possible to protect extremely easily a fault with the ultrasound absorbing body 10 (breakdown or detachment). Consequently, it becomes possible to measure the length of time for the ultrasound absorbing body 10 to breakdown, to discern an appropriate replacement schedule, and possible to discover installation faults during early operations.

Note that while, in the example set forth above, it is illustrated that, in the fault evaluating portion 63 of the calculating/controlling portion 55 of the ultrasonic flow meter 1, the evaluation is that a fault has occurred in the ultrasound absorbing body 10 and when the “difference” between a value that indicates the state of attenuation of the piping-propagated wave W₂ in the standard state (the standard value) and the value acquired by the attenuation status value acquiring portion 62 (the measured value) is greater than a prescribed threshold value, the fault with the ultrasound absorbing body 10 may be evaluated as having occurred if, instead, a “ratio” of the standard value and the measured value exceeds a prescribed threshold value.

Moreover, in the example set forth above an example is illustrated wherein two straight lines are drawn from the maximum peak of the ultrasonic waveform to the minimum peaks on the left and right, where the intersections of these two straight lines with the horizontal axis can be used as the starting time and the ending time of the mixed wave, where the waveform that exists prior to a prescribed time after the time of the start of the mixed wave (or the waveform that exists up until a prescribed time after the end of the mixed waveform) can be identified as the piping-propagated wave; however, the method for identifying the piping-propagated wave is not limited thereto. For example, the size of the waveform may be estimated from the relationship between the wave number and the frequency of the received waveform, and thus the waveform prior to a prescribed time (for example, 5 to 10 μs) from the time at which the maximum peak P_{MAX} occurred in the waveform of the ultrasound (or the waveform after a prescribed time thereafter) may be identified as the piping-propagated wave W₂.

The present invention is not limited to the examples set forth above, but rather appropriate design changes to these examples by those skilled in the art are included in the scope of the present invention insofar as they are provided with the distinctive characteristics thereof. That is, the various elements, positioning, materials, conditions, shapes, sizes, and the like provided in the examples set forth above are not limited to those illustrated, but rather may be changed as appropriate. Moreover, the various elements provided in the examples set forth above may be combined insofar as it is technically possible, and these combinations are included in the scope of the present invention insofar as they include the distinctive features of the present invention.

1. An ultrasonic flow meter comprising:
a first ultrasound transceiving portion that carries out transmission and reception of ultrasound, provided on the outer periphery of an upstream side of piping wherein a fluid is flowing;
a second ultrasound transceiving portion that carries out transmission and reception of ultrasound, provided on an outer periphery of a downstream side of the piping;
a flow rate calculating portion that calculates a flow rate of the fluid based on the time until the reception, by the second ultrasound transceiving portion, of the ultrasound transmitted by the first ultrasound transceiving portion and the time until the reception, by the first ultrasound transceiving portion, of the ultrasound transmitted by the second ultrasound transceiving portion;
an ultrasound absorbing body that absorbs a piping-propagated wave of the ultrasound, provided on an outer periphery of the piping;
a piping-propagated wave identifying portion that identifies the piping-propagated wave;
an attenuation status value calculating portion that acquires a value representing the state of attenuation of the piping-propagated wave identified by the piping-propagated wave identifying portion; and
a fault evaluating portion that evaluates that a fault has occurred in the ultrasound absorbing body when a difference or ratio between the value representing the state of attenuation of the piping-propagated wave in a standard state and the value acquired by the attenuation status value acquiring portion exceeds a prescribed threshold value.

2. The ultrasonic flow meter as set forth in claim 1, wherein:
the piping-propagated wave identifying portion identifies the piping-propagated wave based on the waveform of ultrasound that includes a mixed wave of a fluid-propagated wave and the piping-propagated wave.

3. The ultrasonic flow meter as set forth in claim 1, wherein:
the value representing the state of attenuation of the piping-propagated wave is a root mean square (RMS) of the piping-propagated wave.

4. The ultrasonic flow meter as set forth in claim 1, wherein:
the value representing the state of attenuation of the piping-propagated wave is a difference between a maximum value and a minimum value of the piping-propagated wave.

5. The ultrasonic flow meter as set forth in claim 1, wherein:
the value representing the state of attenuation of the piping-propagated wave is an integrated value of the piping-propagated wave.

6. The ultrasonic flow meter as set forth in claim 1, wherein:
the value representing the state of attenuation of the piping-propagated wave is an SN ratio of the piping-propagated wave.

7. A method for detecting a fault in an ultrasound absorbing body using an ultrasonic flow meter that includes:
a first ultrasound transceiving portion that carries out transmission and reception of ultrasound, provided on the outer periphery of an upstream side of piping wherein a fluid is flowing;
a second ultrasound transceiving portion that carries out transmission and reception of ultrasound, provided on an outer periphery of a downstream side of the piping;
a flow rate calculating portion that calculates a flow rate of the fluid based on the time until the reception, by the second ultrasound transceiving portion, of the ultrasound transmitted by the first ultrasound transceiving portion and the time until the reception, by the first ultrasound transceiving portion, of the ultrasound transmitted by the second ultrasound transceiving portion; and
an ultrasound absorbing body that absorbs a piping-propagated wave of the ultrasound, provided on an outer periphery of the piping; the method comprising:
a piping-propagated wave identifying step for identifying the piping-propagated wave;
an attenuation status value calculating step for acquiring a value representing the state of attenuation of the piping-propagated wave identified in the piping-propagated wave identifying step; and
a fault evaluating step for evaluating that a fault has occurred in the ultrasound absorbing body when a difference or ratio between the value representing the state of attenuation of the piping-propagated wave in a standard state and the value acquired in the attenuation status value acquiring step exceeds a prescribed threshold value.
